(19) United States
(12) Patent Application Publication
(10) Pub. No.: US 2008/0183795 A1
(43) Pub. Date: Jul. 31, 2008

(54) Automated fastener data management system

(75) Inventors: Robert Earl Long, Tremont, IL (US); John Edward Norlin, Washington, IL (US); Ryan Paul Allgaier, East Peoria, IL (US); Tony Francis Sous, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/700,103

(22) Filed: Jan. 31, 2007

(51) Int. Cl. G06F 15/16; G06F 15/163

(52) U.S. Cl. 709/201; 709/202

(57) ABSTRACT

In one aspect, the present disclosure is directed toward a data management system. The system has a corporate level server configured to receive manufacturing component data from a supplier. Additionally, the system has at least one local level server in communication with the corporate level server and configured to request and receive a local subset of the manufacturing component data. The local subset is related to manufacturing components scheduled for assembly by an associated process line.

### TECHNICAL FIELD

The present disclosure is directed to a data management system, and more particularly, to an automated data management system for use in tracking fastener related data.

### BACKGROUND

Conventional manufacturing processes typically involve the assembly of individual components into a finished product. Depending on the intended use of the components and type of joints formed during assembly, several methods and devices can be employed to secure the individual components together. Among the devices commonly used to combine components are mechanical fasteners. Mechanical fasteners grip two or more of the components and effectively use compressive forces to minimize movement between the components.

A typical manufacturing facility can use millions of fasteners having a variety of differing physical characteristics. In addition, the fasteners are used in a multitude of assembly applications where particular physical characteristics are critical to the production and proper operation of the final products. For the purposes of assembly, inspection, and quality monitoring, a data management system is necessary to keep track of each fastener.

U.S. Pat. No. 6,990,866 (the '866 patent) issued to Kibblewhite on Jan. 31, 2006, discloses a fastener with an identifying mark such as a bar code that facilitates tracking fastener data. Information related to the fastener is associated with the identifying mark and is uploaded to a database where it can be used to track and record the manufacturing history of the fastener such as the time and date when the fastener underwent tightening process and the compression load to which the fastener was tightened.

One known data management system utilizes fastener-encoded information similar to that provided by the '886 patent to ensure that the correct fasteners are reliably available for assembly, inspection, and quality monitoring functions. The known data management system begins tracking fastener information when a manufacturer sends a request to a supplier for a specific fastener based on such factors as fastener dimensions, target clamping load, and joint length. From this request, the supplier sets up a fastener serial number and one or more suitable applications intended for the fastener. Data regarding the fastener serial number and associated application are entered into separate computer files referred to as “Part Data” and “Application Data”, respectively. After these files are created, they are then manually emailed to a member of the manufacturer's fastener team. For ultrasonic fasteners, a sensor is attached to each fastener, and a zero length calibration is performed generating additional data specific to that fastener. The additional fastener-specific data is entered into a computer file referred to as “Fastener Data”. After the Fastener Data file is created, it too is emailed to the manufacturer. Once all three computer files are received, they are manually removed from the email and entered into a directory on a shared file server accessible only to members of the fastener team. While the files are in the directory, a member of the fastener team uses a portable computer such as a personal data assistant (PDA) to retrieve the files from the directory and references them during tightening and inspection of the fastener. During the tightening and inspection processes, additional data such as the clamping load in the fastener is generated and must be manually uploaded back into the directory.

Although this data management system is designed to ensure that fastener data is available for assembly, inspection, and quality monitoring functions, an inherent susceptibility to errors may reduce the system's reliability. For example, due to common email errors such as server errors, human errors, SPAM filters, and automatic deletions from the inbox, the transmission of the files from the supplier to the manufacturer may be prone to failure. In addition, because transfer of these files from email to the shared directory is a manual process, transmission failures may occur if the receiving individual is absent from the office due to illness or vacation. If the transmission fails, it may be possible for the physical fastener to reach the production facility before the data files do, and the assembly process could subsequently be interrupted or even halted.

Additional sources of possible errors are the lack of version control on the data files and requirement of manual synchronization of the PDA's with the shared directory. Each time a Part Data, Application Data, and Fastener Data file is sent to the manufacturer, it may have the same name as a previously sent file. This may create a possibility that a newer file could overwrite an older file in the directory. In addition, because the synchronization process is a manual process, it may be prone to human error such as forgetting to synchronize before using the PDA for tightening or inspecting.

The disclosed data management system is directed to overcoming one or more of the problems set forth above.

### SUMMARY OF THE INVENTION

In one aspect, the present disclosure is directed toward a data management system. The system includes a corporate level server configured to receive manufacturing component data from a supplier. Additionally, the system includes at least one local level server in communication with the corporate level server and configured to request and receive a local subset of the manufacturing component data. The local subset is related to manufacturing components scheduled for assembly by an associated process line.

Consistent with a further aspect of the disclosure, a method is provided for managing fastener data. The method includes uploading supplier-supplied fastener data and downloading a first subset of the supplier-supplied fastener data in response to an automatic first request. The first subset relates to manufacturing components to be used in a plurality of manufacturing processes. Furthermore, the method includes downloading a second subset of the first subset of the supplier-supplied fastener data in response to an automatic second request, and utilizing the second subset in a manufacturing process.

### BRIEF DESCRIPTION OF THE DRAWINGS

FIG. 1 is a block diagram of a fastener data management system, according to an exemplary disclosed embodiment;

FIG. 2 is a block diagram of a fastener master database, according to an exemplary disclosed embodiment; and

FIG. 3 is a flow diagram of a method, according to an exemplary disclosed embodiment.

### DETAILED DESCRIPTION

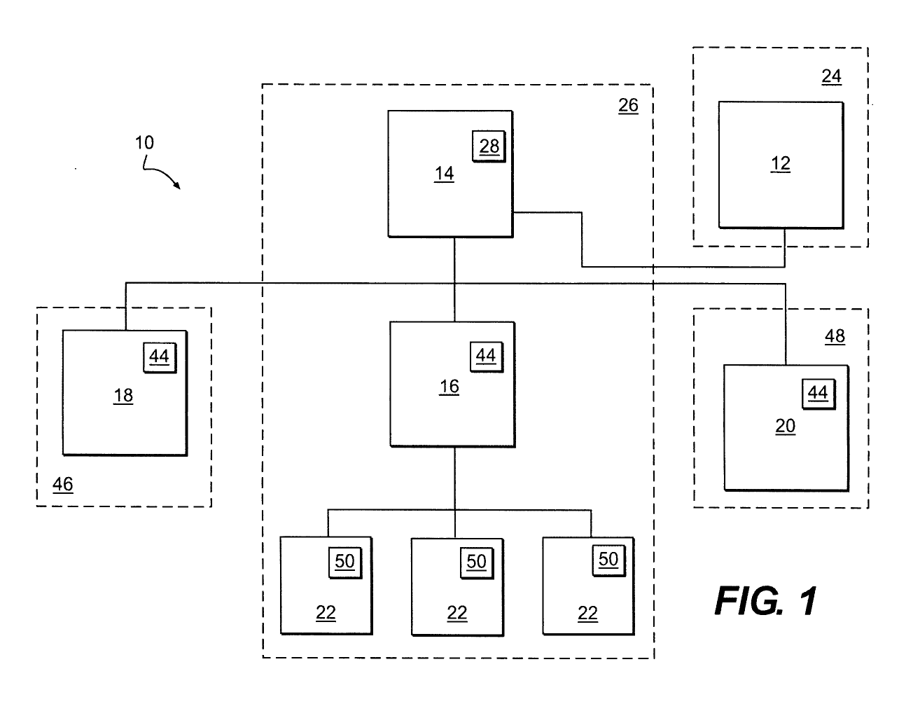

FIG. 1 provides a block diagram of a data management system 10 according to an exemplary embodiment. The data management system may be used to transmit data associated with a fastener (not shown) to an assembly, inspection, or quality monitoring process. Such data may include, for example, a fastener identification number, an associated application in which the fastener may be used, and physical geometry data including length calibration and physical characteristics associated with the fastener. Data management system 10 may include a fastener supplier server 12 for producing fastener data, and a corporate level server 14 for receiving fastener data from fastener supplier server 12. Data management system 10 may also include a plant level server 16, a sub-contractor level server 18, and a dealer level server 20, all of which may be configured to receive fastener data from corporate level server 14. Furthermore, data management system 10 may include a plurality of local level servers 22, wherein each local level server 22 has an associated manufacturing processing line (not shown) and is configured to send fastener data to and receive fastener data from plant level server 16.

Fastener supplier server 12 may be located within a fastener manufacturing facility 24. Furthermore, fastener supplier server 12 may include a personal (PC) or mainframe computer selectively activated or reconfigured by a computer program stored in the memory of the computer to generate data relating to a particular fastener (not shown) produced by facility 24. Fastener supplier server 12 may also be implemented or provided with a wide variety of components or subsystems including, for example, one or more of the following: a processor, a co-processor, a register, and/or other data processing devices and subsystems. Fastener supplier server 12 may communicate fastener data to and/or receive fastener data from corporate level server 16 through the use of an internet, wireless area network (WAN), and/or local area network (LAN) connection (not referenced), as illustrated in FIG. 1. The means of communication over the internet, WAN, and/or LAN may include XML or HTML formats and may use the standard or secure Hyper Text Transfer Protocol (HTTP). In an exemplary embodiment, a firewall may prevent access to fastener supplier server 12 and fastener data management system 10 by unauthorized outside entities. It is further contemplated that fastener supplier server 12 may require user authentication, such as password verification, in order to prevent unauthorized users from gaining access to fastener data management system 10. Such user authentication may include user accounts used purely for automation, if desired.

Corporate level server 14 may be located anywhere within a manufacturing facility 26 or in a corporate office associated with manufacturing facility 26. Furthermore, corporate level server 14 may include a personal (PC) or mainframe computer selectively activated or reconfigured by a computer program stored in memory of the computer to send and receive data relating to the particular fastener produced by manufacturing facility 24. Data received from fastener supplier server 12 may be stored in a master database 28. Corporate level server 14 may also be implemented or provided with a wide variety of components or subsystems including, for example, one or more of the following: a processor, a co-processor, a register, and/or other data processing devices and subsystems. Corporate level server 14 may also communicate or transfer fastener data to and/or from fastener supplier server 12, sub-contractor level server 18, and dealer level server 20 through the use of an internet connection. The content of the data being transferred can be a complete copy of the relevant data in master database 28, a differential copy including only new or updated records, or a subset of the copies previously mentioned with various filter criteria applied. It should be understood that corporate level server 14 may communicate or transfer fastener data to and/or from plant level server 16 through an intranet, LAN, WAN, or internet connection (not referenced), as illustrated in FIG. 1. The means of communication over the internet, WAN, and/or LAN may include XML or HTML formats and may use the standard or secure Hyper Text Transfer Protocol (HTTP). In an exemplary embodiment, a firewall may prevent access to corporate level server 14 and fastener data management system 10 by unauthorized outside entities. It is further contemplated that corporate level server 14 may require user authentication, such as password verification, in order to prevent unauthorized users from gaining access to fastener data management system 10. Such user authentication may include user accounts used purely for automation, if desired.

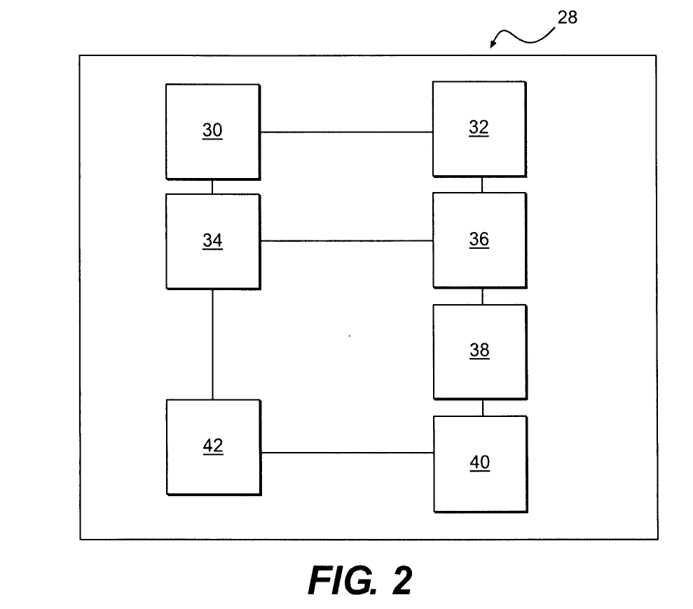

FIG. 2 illustrates an exemplary embodiment of master database 28. Master database 28 may include seven types of database tables related to the fasteners produced by fastener manufacturing facility 24. Such tables may include a part table 30, an application table 32, a fastener table 34, an event table 36, a unit table 38, a schedule table 40, and a scheduled fastener table 42. These tables may be written in an XML, HTML, or any format known in the art that may facilitate communication through an intranet, internet, LAN, or WAN communication system. Such tables may exist as logical elements in a single or multiple files. Although the exemplary embodiment discloses seven types of tables related to the fasteners produced by fastener manufacturing facility 24, it is contemplated that master database 28 may include any number of tables, such as, for example, a manufacturer tracking table, associated with the fastener that may facilitate the assembly or inspection processes. Part table 30 may be utilized to assign and track a part number for each type of fastener produced by fastener manufacturing facility 24. Application table 32 may be utilized to assign and track an application number identifying the type of joint to be secured by particular types of fasteners. Fastener table 34 may be used to assign and track a serial number uniquely identifying each particular fastener. Event table 36 may be used to assign and track an event identification number signifying either a tightening event or an inspection event for each particular fastener. Unit table 38 may be used to assign and track a unit identification number representing the assembly processing line for which the fastener is being requested. Schedule table 40 may be used to assign and track a schedule identification number representing the intended or actual schedule of assembly for a particular fastener. Scheduled fastener table 42 may be used to relate and track the schedule identification number from schedule table 40 and the serial number from fastener table 34.

Referring back to FIG. 1, plant level server 16 may be located anywhere within manufacturing facility 26. Furthermore, plant level server 16 may include a personal (PC) or mainframe computer selectively activated or reconfigured by a computer program stored in memory of the computer to send and receive data relating to the fasteners produced by fastener manufacturing facility 24. Such data may be stored in a secondary database 44 having a similar architecture to master database 28. Plant level server 16 may also be implemented or provided with a wide variety of components or subsystems including, for example, one or more of the following: a processor, a co-processor, a register, and/or other data processing devices and subsystems. Plant level server 16 may communicate or transfer fastener data to and/or from corporate level server 14 and local level servers 22 through an intranet, LAN, WAN, or internet connection (not referenced), as illustrated in FIG. 1. It is contemplated that plant level server 16 may require user authentication, such as password verification, in order to prevent unauthorized users from gaining access to fastener data management system 10. Such user authentication may include user accounts used purely for automation, if desired. It is further contemplated that in systems utilizing small facilities, plant level server 16 may be excluded from the system, and data may be communicated directly between corporate level server 14 and local servers 22.

Sub-contractor level server 18 and dealer level server 20 may be located anywhere within a sub-contractor facility 46 and a dealer facility 48, respectively. Additionally, sub-contractor level server 18 and dealer level server 20 may be located at or near an associated processing line (not shown) within sub-contractor facility 46 and dealer facility 48, respectively. It is contemplated that sub-contractor level server 18 and dealer level server 20 may be integrated with the associated processing line, if desired. Furthermore, sub-contractor level server 18 and dealer level server 20 may even include a personal (PC) or mainframe computer selectively activated or reconfigured by a computer program stored in memory of the computer to send and receive data relating to the fasteners produced by fastener manufacturing facility 24. Such data may be stored in secondary database 44. Sub-contractor level server 18 and dealer level server 20 may also be implemented or provided with a wide variety of components or subsystems including, for example, one or more of the following: a processor, a co-processor, a register, and/or other data processing devices and subsystems. Sub-contractor level server 18 and dealer level server 20 may also communicate or transfer fastener data to and/or from corporate level server 14 through the use of an internet connection. It is contemplated that sub-contractor level server 18 and dealer level server 20 may require user authentication, such as password verification, in order to prevent unauthorized users from gaining access to fastener data management system 10. Such user authentication may include user accounts used purely for automation, if desired.

Local level servers 22 may be located at or near an associated processing line (not shown). It is contemplated that local servers 22 may be integrated with the associated processing line, if desired. Furthermore, each local level server 22 may include a personal (PC) or mainframe computer selectively activated or reconfigured by a computer program stored in memory of the computer to send and receive data relating to the fasteners produced by fastener manufacturing facility 24. Such data may be stored in a local database 50 having an architecture similar to master database 28. Local level server 22 may also be implemented or provided with a wide variety of components or subsystems including, for example, one or more of the following: a processor, a co-processor, a register, and/or other data processing devices and subsystems. Local level server 22 may communicate or transfer fastener data to and/or from plant level server 16 through an intranet, LAN, WAN, or internet connection (not referenced), as illustrated in FIG. 1. It is contemplated that local level server 22 may require user authentication, such as password verification, in order to prevent unauthorized users from gaining access to fastener data management system 10. Such user authentication may include user accounts used purely for automation, if desired.

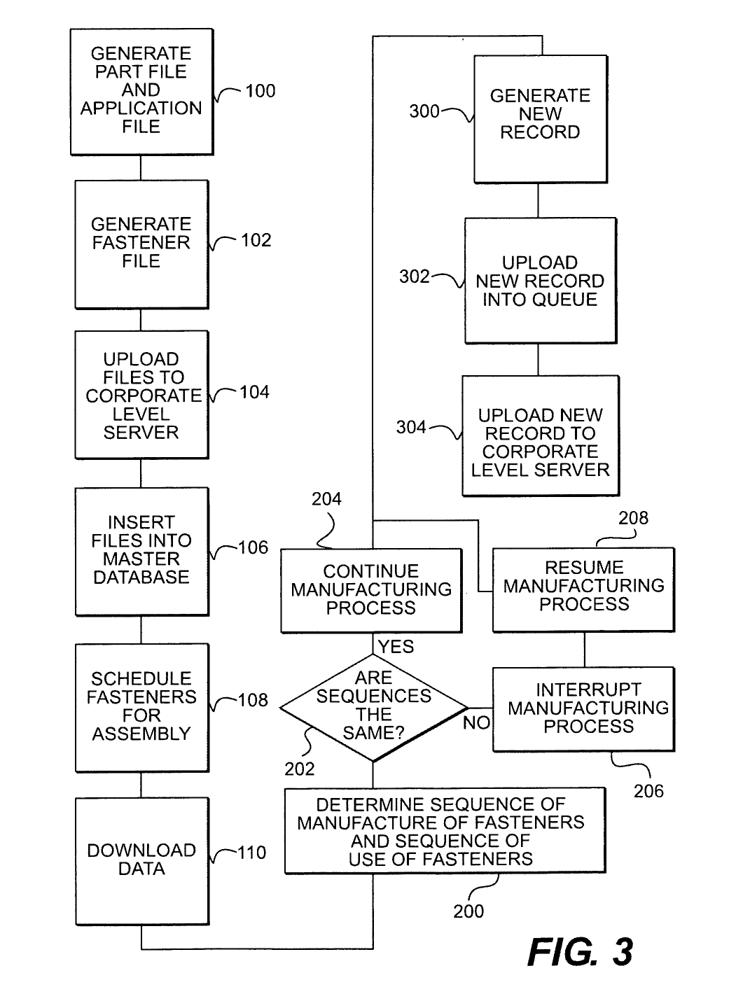

FIG. 3 illustrates an exemplary method used by fastener data managing system 10 to transmit data associated with the fastener to an assembly, inspection, or quality monitoring process. FIG. 3 will be discussed in more detail below.

### INDUSTRIAL APPLICABILITY

The disclosed fastener data managing system may help ensure that fastener-associated data is reliably available for assembly, inspection, and quality monitoring functions. In particular, the disclosed fastener data management system may replace manual data transmission processes with an automated information technology infrastructure. By permitting data management automation at multiple levels within the manufacturing process, the likelihood of assembly errors may be reduced or even eliminated. The method for managing fastener data will now be explained.

As illustrated in FIG. 3, the method may begin when a manufacturer submits a fastener request to a fastener supplier. Such request may specify the type of fastener required and the application for which the fastener may be intended. For example, the request may include fastener geometric dimensions, a target clamping load, and an expected joint length. Upon receiving the request from the manufacturer, fastener supplier server 12 may generate data regarding the fastener and associated application (step 100). In addition, in the course of manufacturing the requested fastener, an associated identification reference may be generated. Also, a unique identification mark such as a bar code may be placed or etched onto the fastener representing the associated identification reference (step 102). The mark and identification reference may include information such as, for example, a part number, an engineering change number, the supplier's name, a date of manufacture, and/or a sequence number. When all of the data (i.e. fastener data, application data, and identification reference) are created and the manufacture of the requested fastener has been completed, the data may be entered into one or more files, which may be uploaded to corporate level server 14 (step 106), and the fastener may be shipped to manufacturing facility 26. It should be understood that the uploading of the files to corporate level server 14 may be performed via the internet, and may be an automatic process. After being uploaded to corporate level server 12, the generated data may be manually or automatically entered into part table 30, application table 32, and fastener table 34 located in master database 28 (step 106).

After the data is sorted into fastener tables 30-34, corporate level server 14 may allow the requested fastener to be scheduled for usage in an assembly process (step 108). Scheduling may be performed either manually or by an automated process and used to determine which data will be retrieved by plant level server 16, sub-contractor level servers 18, dealer level servers 20, and/or local level servers 22 in the next download. Periodically, each sub-contractor level server 18, dealer level server 20, and/or local level server 22 may request and download an appropriate set of data from plant level server 16 to perform a scheduled tightening or inspection event (step 110). The download requests may occur at a frequency dependant on a scheduled manufacturing process utilizing fasteners and/or the usage of fasteners at the process line associated with sub-contractor level server 18, dealer level server 20, and/or local level server 22, and can be manually configured. If the download fails for whatever reason, the existing information already on sub-contractor server 18, dealer server 20, and/or local level server 22 may be preserved and utilized for the tightening or inspection process.

When sub-contractor level server 18, dealer level server 20, and/or local level server 22 are referenced to facilitate either inspection or tightening of the requested fastener, required data associated with the requested fastener such as calibration data, may be present in sub-contractor level server 18, dealer level server 20, and/or local level server 22, as a result of the periodic download process. If sub-contractor level server 18, dealer level server 20, and/or local level server 22 attempt an assembly or inspection process with a fastener for which it does not have information, sub-contractor level server 18, dealer level server 20, and/or local level server 22 may access plant level server 16 and retrieve the information necessary to complete the operation. However, if the necessary fastener information is unavailable on plant level server 16, assembly of the requested fastener may be prevented and another fastener, about which sub-contractor level server 18, dealer level server 20, and/or local level server 22 have information, may instead be processed.

When the appropriate data set is downloaded to sub-contractor level server 18, dealer level server 20, or local level server 22, the sequence of manufacture of the fasteners may be compared with the sequence in which the fasteners are to be used (step 200). This may be accomplished by, for example, comparing the time and date of manufacture recorded in the identification reference of each fastener with the schedule data for each fastener. Sub-contractor level server 18, dealer level server 20, or local level server 22 may determine whether the sequences are the same (step 202). If it is determined that the sequences are the same (step 202: Yes), then sub-contractor level server 18, dealer level server 20, or local level server 22 may continue with the manufacturing process (step 204). However, if it is determined that the sequences are different (step 202: No), then sub-contractor level server 18, dealer level server 20, or local level server 22 may interrupt the manufacturing process (step 206). The manufacturing process may be resumed (step 208) after the sequences are rectified, a threshold of time passes, or the fasteners are removed and a new set of fasteners are delivered to the system.

Each tightening or inspection process may generate a new record (step 300). These new records may include serial numbers of the processed fasteners, timestamps, process mode descriptions (tightening or inspecting), and/or a process resulting characteristic such as an induced load measured by the attached strain sensors, if included. Each new record may be inserted into an upload queue (302). Periodically, sub-contractor level server 18, dealer level server 20, and/or local level server 22 may upload the generated records to corporate level server 14 (step 304) via plant level server 16, where it may be accessed by other sub-contractor level servers 18, dealer level servers 20, and/or local servers 22 for tracking of the manufactured products used by each respective entity. It should be understood that when the generated records are uploaded to corporate level server 14, they may be stored in a database accessible to other manufacturing computer systems for traceability and quality monitoring.

The disclosed fastener data management system may help ensure that fastener data associated with an identification number is reliably available for assembly, inspection, and quality monitoring functions. By automating each step in the process, manually caused errors that are inherent to existing systems may be reduced or even eliminated, which can improve efficiency of the manufacturing process.

It will be apparent to those skilled in the art that various modifications and variations can be made in the disclosed system without departing from the scope of the disclosure. Other embodiments will be apparent to those skilled in the art from consideration of the specification disclosed herein. It is intended that the specification and examples be considered as exemplary only, with a true scope being indicated by the following claims and their equivalents.

1-20. (canceled)

21. A data management system, comprising:
a corporate level server in communication with a component supply facility server;
a corporate level data storage device associated with the corporate level server, the corporate level storage device including data received from the component supply facility server relating to physical components manufactured in a facility associated with the component supply facility server;
a plant level server in communication with the corporate level server and associated with a manufacturing facility;
a plant level data storage device associated with the plant level server, the plant level storage device including data received from the corporate level server relating to physical components sent from the component supply facility to the manufacturing facility;
at least one local level server in communication with the plant level server, the at least one local level server being associated with a manufacturing process line; and
at least one local level data storage device, the at least one local level data storage device being associated with a local level server and including data received from the plant level server and relating to one or more physical components scheduled for use by the manufacturing process line.

22. The data management system of claim 21, wherein the plant level data storage device further includes data received from the at least one local level server.

23. The data management system of claim 22, wherein the data received by the plant level server from the at least one local level server relates to one or more physical components that have been used by the manufacturing process line associated with the at least one local level server.

24. The data management system of claim 23, wherein the corporate level data storage device further includes data received from the plant level server.

25. The data management system of claim 24, wherein the data received by the corporate level server from the plant level server relates to one or more physical components that have been used by the manufacturing process line associated with the at least one local level server.

26. The data management system of claim 25, wherein the data received from the component supply facility server includes a description of the component and an intended use for the component.

27. A method for selecting and using a component in a manufacturing process, comprising:
receiving a request for a component to be used in the manufacturing process;
generating component data relating to the component;
sending the component data to a computer associated with a manufacturing line;
sending the component to the manufacturing line;
comparing the received component to the received component data; and
performing the manufacturing process based on the comparison.

28. The method of claim 27, wherein comparing the received component to the received component data includes determining whether the component has been received by the manufacturing line and whether the component data has been received by the computer.

29. The method of claim 28, further including selecting an alternative component for use in the manufacturing process if either the component has not been received by the manufacturing line or the component data has not been received by the computer.

30. The method of claim 27, wherein sending the component data and sending the component each include selecting a time for sending based on a scheduled use of the component in the manufacturing process.

31. The method of claim 30, further including comparing the scheduled use of the component with a scheduled use of other components to be utilized in the manufacturing process.

32. The method of claim 31, further including interrupting the manufacturing process if a sequence in which the components are to be used in the manufacturing process is different than a desired sequence.

33. The method of claim 27, further including receiving post-manufacturing component data relating to post-manufacturing characteristics of the component used in the manufacturing process.

34. The method of claim 33, further including combining component data created before the performance of the manufacturing process with the post-manufacturing component data.

35. A data management system, comprising:
a corporate level server in communication with a component supply facility server;
a corporate level data storage device associated with the corporate level server, the corporate level storage device including data received from the component supply facility server relating to physical components manufactured in a facility associated with the component supply facility server;
a plant level server in communication with the corporate level server and associated with a manufacturing facility;
a plant level data storage device associated with the plant level server, the plant level storage device including data received from the corporate level server relating to physical components sent from the component supply facility to the manufacturing facility;
at least one local level server in communication with the plant level server, the at least one local level server being associated with a manufacturing process line;
at least one local level data storage device, the at least one local level data storage device being associated with a local level server and including data received from the plant level server and relating to one or more physical components scheduled for use by the manufacturing process line;
at least one non-manufacturing level server in communication with the corporate level server and associated with a non-manufacturing facility; and
at least one non-manufacturing level data storage device, the at least one non-manufacturing level data storage device being associated with a non-manufacturing level server and including data received from the corporate level server and relating to one or more physical components that have been used by the manufacturing process line.

36. The data management system of claim 35, wherein the plant level data storage device further includes data received from the at least one local level server.

37. The data management system of claim 36, wherein the data received by the plant level server from the at least one local level server relates to one or more physical components that have been used by the manufacturing process line associated with the at least one local level server.

38. The data management system of claim 37, wherein the corporate level data storage device further includes data received from the plant level server.

39. The data management system of claim 38, wherein the data received by the corporate level server from the plant level server relates to one or more physical components that have been used by the manufacturing process line associated with the at least one local level server.

40. The data management system of claim 39, wherein the data received from the component supply facility server includes a description of the component and an intended use for the component.
